(19) United States
(12) Patent Application Publication
(10) Pub. No.: US 2020/0086964 A1
(43) Pub. Date: Mar. 19, 2020

(54) Anterior Zone Of An Aircraft Having A Simplified Structure

(71) Applicant: Airbus Operations S.A.S., Toulouse (FR)

(72) Inventor: Philippe Bernadet, Colomiers (FR)

(73) Assignee: Airbus Operations S.A.S., Toulouse (FR)

(21) Appl. No.: 16/567,144

(22) Filed: Sep. 11, 2019

(30) Foreign Application Priority Data
Sep. 13, 2018 (FR) 18 58256

(51) Int. Cl. B64C 1/06; B64C 25/04; B64C 1/18

(52) U.S. Cl. CPC B64C 1/061; B64C 1/18; B64C 25/04

(57) ABSTRACT

An anterior zone of an aircraft, having a fuselage with frames, includes a cockpit, arranged partly above a front landing gear compartment, and a service area. The floor includes: a rear main crossbeam which extends in the plane of a frame situated in the service area and which is fixed to said frame, a port main spar and a starboard main spar, the rear ends of which are fixed to the rear main crossbeam, one or more secondary crossbeams, fixed to the port and starboard main spars, and one or more auxiliary spars. The number of crossbeam/frame attachments is reduced. The dimensioning of the principal beams of the floor is optimised; the result thereof is a weight saving.

### FIELD OF THE INVENTION

The invention relates to a floor of an anterior zone of an aircraft, the invention applies in particular to passenger transport aircraft, in which the anterior zone accommodates a cockpit and a service area behind the cockpit, with storage furniture (known as “galley”) and toilets.

Throughout the description, in the usual manner, the terms “longitudinal direction” or “longitudinally” refer to a direction parallel to the roll axis or X axis of the aircraft (this axis linking the nose to the tail of the aircraft), and the terms “transverse direction” and “transversally” refer to a direction parallel to the pitch axis or Y axis of the aircraft (this axis passing through the ends of the wings of the aircraft), the axes X and Y being orthogonal to one another and orthogonal to the axis Z or yaw axis, which corresponds to the direction of gravity when the aircraft is resting on a horizontal ground.

### BACKGROUND OF THE INVENTION

A floor of an anterior zone of an aircraft usually comprises crossbeams borne by frames of the fuselage, spars borne by the crossbeams and panels covering all the surface defined by the grid of said crossbeams and spars.

The crossbeams therefore constitute the principal beams of the floor. A crossbeam is provided at each frame of the fuselage and each crossbeam is directly fixed to the frame at its two ends, which induces a significant number of ties between the crossbeams and the frames. In proximity to the ties of the crossbeams on the frames there must also be provided fixings of the roof of the front landing gear compartment which is located partly under the cockpit.

### BRIEF SUMMARY OF THE INVENTION

Aspects of the invention may propose a simplified structure for the floor of the anterior zone, in which the number of crossbeams/frame fixings is reduced.

An aspect of the invention relates to an anterior zone of an aircraft, the aircraft comprising a fuselage with frames, the anterior zone, gating a cockpit, arranged partly above a front landing gear compartment, and a service area, the anterior zone having a floor comprising crossbeams, spars and one or more floor panels. The floor according to an embodiment of the invention comprises:
a rear main crossbeam extending in the plane of a frame situated in the service area, which rear main crossbeam is fixed to said frame,
a port main spar and a starboard main spar, which main spars have a rear end fixed to the rear main crossbeam,
one or more secondary crossbeams, fixed to the port and starboard main spars, the secondary crossbeams not being fixed to any frame, and being borne by the main spars, the floor not comprising any crossbeam fixed to a frame in the cockpit,
one or more auxiliary spars.

Thus, according to an embodiment of the invention, the principal beams are not crossbeams, apart from the rear main crossbeam, but spars, in particular the port and starboard main spars.

This is advantageous in a number of ways. Firstly, since the secondary crossbeams are not fixed to frames, the number of crossbeam/frame ties is considerably reduced.

It will be noted secondly that the dimension of the cockpit (and even of the anterior zone) in the transverse direction is greater than its dimension in the longitudinal direction. The principal beams (spars) in a floor according to an embodiment of the invention are therefore shorter than those (crossbeams) of the known anterior floors. They can consequently be less thick (and lighter) for one and the same cockpit and service area loading to be supported. In other words, the dimensioning of the principal beams of the floor is optimised according to an aspect of the invention.

According to a possible feature of the invention, the port and starboard main spars each have a front end fixed to a structural element of the front landing gear compartment, the structural element used being advantageously situated in front of the cockpit.

A front main crossbeam fixed to a frame could have been provided like the rear main crossbeam to take up the loads of the main spars; but such a front main crossbeam would have added to the weight of the aircraft and to the number of crossbeam/frame ties. An aspect of the invention exploits the proximity, at the front of the cockpit, between the floor of the cockpit and the structure of the front landing gear compartment, by using a structural element of the compartment instead of an additional crossbeam to bear the main spars at their front end.

In the absence of structural element of the compartment capable of taking up the loads of the floor according to an embodiment of the invention at the front end of the cockpit, an additional structural element is provided. It can be a front main crossbeam, fixed to a frame, or a link element between the floor according to an embodiment of the invention and the sealed front nose cone of the aircraft. Such an arrangement is less advantageous but remains possible.

According to a possible embodiment of the anterior zone floor according to the invention:
the secondary crossbeams do not extend over all the transverse dimension of the anterior zone; for example, the secondary crossbeams extend only from the port main spar to the starboard main spar,
the floor panel or panels cover a surface delimited transversely by the port and starboard main spars. Obviously, this surface corresponds at least to a “walking surface” for the crew members of the aircraft (zones the crew members need to access and on which they are therefore required to walk). Preferably, it extends longitudinally at least between two secondary crossbeams.

In this embodiment, the secondary crossbeams extend only at most from the port main spar to the starboard main spar, they do not extend to the fuselage; likewise, the floor panel or panels do not extend transversely beyond (towards the fuselage) the port and starboard main spars. This arrangement therefore leaves, on each side of the cockpit, a lateral band without crossbeam and panel. In the aircraft of the state of the art, the numerous crossbeams of the anterior zone are that many obstacles to the running of systems through the floor. The presence here of two lateral bands without crossbeam and panel according to an embodiment of the invention greatly facilitates the running of the systems.

According to a possible feature, the anterior zone floor according to the invention comprises a crossbeam, called reinforcing crossbeam, fixed to a frame of the aircraft situated in the service area, in front of the rear main crossbeam. The reinforcing crossbeam is for example situated at the junction between the cockpit and the service area while the rear main crossbeam is situated at the rear end of the service area, for example at the junction between the service area and the passenger cabin. The reinforcing crossbeam can be fixed to the frame which precedes the one to which the rear main crossbeam is fixed.

In other words, in this embodiment, the floor ultimately comprises two crossbeams fixed to frames, both situated in the service area, which is the point of the anterior zone supporting the heaviest loads. The other crossbeams, situated in front of the reinforcing crossbeam, are not fixed to frames and are, in this respect, qualified as secondary crossbeams.

Similarly, according to a possible feature of the invention, the anterior zone floor comprises a port reinforcing spar and a starboard reinforcing spar which, like the port and starboard mains spars, each have a rear end fixed to the rear main crossbeam, and a front end which, preferably, is fixed to the structural element of the front landing gear compartment.

According to a possible feature of the invention, the structural element of the front landing gear compartment to which are fixed the front ends of the port and starboard main spars, as well as, if appropriate, the front ends of the port and starboard reinforcing spars, forms part of a horizontal section of roof of the gear compartment.

The invention extends to an aircraft equipped with an anterior zone floor according to the invention.

Other details and advantages of the present invention will become apparent on reading the following description, which refers to the attached schematic drawings and relates to preferential embodiments, provided as nonlimiting examples.

### BRIEF DESCRIPTION OF THE DRAWINGS

FIG. 1 is a perspective schematic view from above and behind an anterior zone floor according to an embodiment of the invention, in which the floor panels have not been represented.

FIG. 2 is a perspective schematic view from above and from the front of the floor of FIG. 1 mounted in an aircraft fuselage and with its floor panels.

FIG. 3 is a profile schematic view of an aircraft equipped with an advanced front gear compartment (qualified thus because of its position) and of a floor according to an embodiment of the invention.

### DETAILED DESCRIPTION

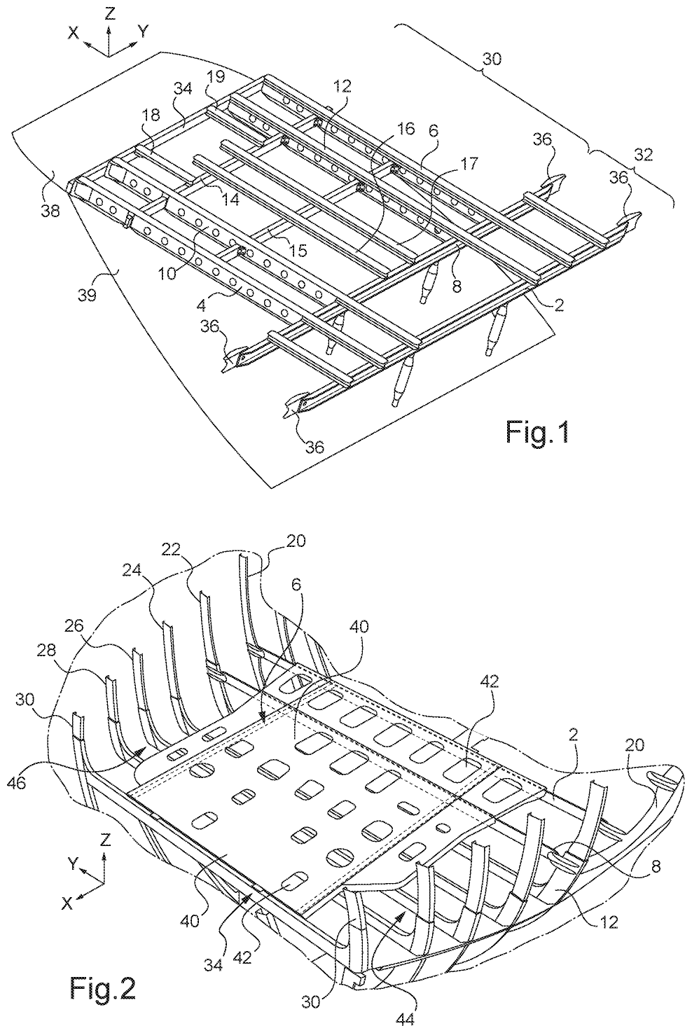

FIG. 1 represents the “skeleton” of a floor of an anterior zone of a passenger transport aircraft, which anterior zone comprises a part 30 receiving a cockpit and a part 32 receiving a service area with galley and toilets (not represented).

Under this floor, there are, from the front to the rear of the aircraft, a front landing gear compartment (simply called “front gear compartment” hereinbelow) and a technical hold which extends under the cockpit and under the service area. The technical hold is open in the upper part and is pressurised like the cockpit.

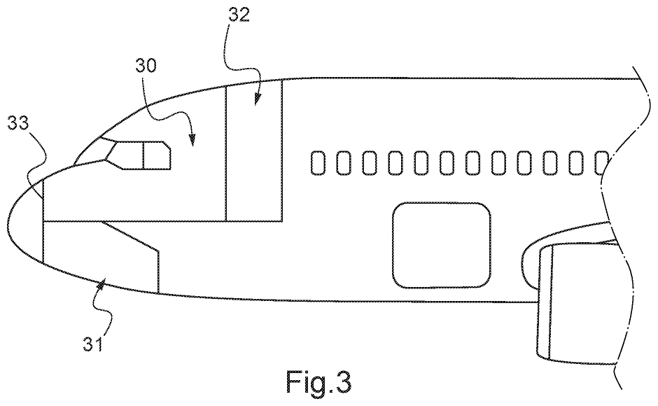

There are mainly two types of front gear compartment: so-called “conventional” front gear compartments, which extend essentially under the cockpit, or even only in the central or rear part of the cockpit, such that there is a pressurised space between the front gear compartment and the sealed nose cone of the aircraft; and so-called “advanced” front gear compartments such as that illustrated in FIG. 3, which extend to the sealed nose cone 33 of the aircraft. The front gear compartment 31 whose roof can be seen in FIGS. 1 and 2 is an “advanced” compartment. Aspects of the invention apply to the aircraft provided with an advanced gear compartment and for the aircraft provided with a conventional gear compartment. However, it is more advantageous in the case of an advanced compartment for which the absence of free space (pressurised) between the sealed nose cone and the gear compartment complicates the running of the systems to the cockpit.

The roof of the (advanced) front gear compartment that can be seen in FIG. 1, comprises a horizontal section 38 and an inclined section 39.

The floor of the anterior zone illustrated in FIGS. 1 and 2 comprises a rear main crossbeam 2 fixed onto and borne by a frame 20 of the fuselage of the aircraft which is situated in the service area. The fixing of the rear main crossbeam 2 onto the frame 20 can be done using ties 36 as in the known prior floors.

The anterior zone floor according to an embodiment of the invention illustrated in FIGS. 1 and 2 also comprises a port main spar 4 and a starboard main spar 6 whose rear ends are fixed onto and borne by the rear main crossbeam 2, and whose front ends are fixed onto and borne by a structural element 34 forming part of the horizontal section of roof 38 of the front gear compartment.

It should be noted that the roof of the front gear compartment is dimensioned so as to be able to withstand a significant pressure difference since it is exposed on one side (above the compartment) to the pressure prevailing in the cockpit and on the other side to the pressure outside the aircraft. The roof of the compartment therefore comprises structural elements capable of taking up significant loads, such as the beam 34 in the rear part of the horizontal section of roof 38. An aspect of the invention here advantageously exploits this feature.

The anterior zone floor according to an embodiment of the invention illustrated in FIGS. 1 and 2 also comprises a reinforcing crossbeam 8, and a port reinforcing spar 10 and a starboard reinforcing spar 12.

The reinforcing crossbeam 8 is fixed to a frame 22 of the fuselage. The frame 22 is the one which precedes the frame 20, that is to say the one which is situated immediately in front of the frame 20 to which the rear main crossbeam 2 is fixed. The reinforcing spars 10 and 12 are fixed in the same way as the main spars 4 and 6, that is to say that they are fixed to the rear main crossbeam 2 by their rear end and to the structural element 34 of the front gear compartment by their front end.

It should be noted that the port 4 and starboard 6 main spars, and the reinforcing spars 10 and 12, are also borne by the reinforcing crossbeam 8.

The anterior zone floor according to an embodiment of the invention illustrated in FIGS. 1 and 2 also comprises two secondary crossbeams 14, 15 which extend only from the port main spar 4 to the starboard main spar 6. These secondary crossbeams are fixed onto and borne by the main spars 4 and 6 and the reinforcing spars 10 and 12. The floor could comprise other secondary crossbeams or, on the contrary, a single secondary crossbeam.

The anterior zone floor according to an embodiment of the invention illustrated in FIGS. 1 and 2 also comprises auxiliary spars 16, 17, 18, 19. The auxiliary spars 16, 17 extend from the reinforcing crossbeam 8 to the secondary crossbeam 14, to which they are fixed. The auxiliary spars 18, 19 extend from the secondary crossbeam 14 to the structural element 34 of the front gear compartment, to which they are fixed.

The network of the crossbeams and auxiliary spars is not limited to that illustrated in the attached figures. The distribution of the crossbeams and auxiliary spars can vary and the positioning of the various auxiliary spars and secondary crossbeams should be determined as a function of the mechanical loads that the floor must withstand. As an example, the pilot and copilot seats having a base, it is preferable to position the intersections of the crossbeams and auxiliary spars in line with the fixings of these bases for reasons of structural efficiency. Beyond this logic, crossbeams and/or auxiliary spars can be added if the grid size is too great to ensure the rigidity of the walking zones of the floor for example.

The anterior zone floor according to an embodiment of the invention finally comprises floor panels. As a variant, a single floor panel 40 is provided covering all the crew walking surface, this service comprising all of the service area and only a part of the cockpit. In the example illustrated, this (single) panel is holed, holes 42 being provided in places to reduce the weight of the floor while ensuring the resistance to the global mechanical loads that the floor is subjected to. The holes can be plugged by lighter plates in order to ensure placement of the floor covering (of fitted carpet type) and to withstand the crew walking load.

As can be seen in FIG. 2, the frames 24, 26, 28, which precede the frame 22 to which the reinforcing crossbeam 8 is fixed, do not bear any crossbeam. No crossbeam encumbers the space 44 (lateral band) extending transversely between the port main spar 4 and the fuselage, as for the space 46 (lateral band) extending transversely between the starboard main spar 6 and the fuselage. These two lateral bands are not crew walking zones but zones receiving mainly navigation tools or other equipment, even lost zones not used in the cockpit floor. As a consequence of this, the lateral bands 44 and 46 can advantageously be without floor panel (as illustrated in FIG. 2). They are therefore without any structural floor element (neither crossbeam nor floor panel). This means that no obstacle opposes the vertical running of the systems between the cockpit and the technical hold in said lateral bands 44 and 46.

The invention extends to any variant accessible to the person skilled in the art, that is to say following within the scope delimited by the attached claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An anterior zone of an aircraft comprising a fuselage with frames, the anterior zone accommodating a cockpit, arranged partly above a front landing gear compartment, and a service area, the anterior zone having a floor comprising crossbeams, spars and one or more floor panels, wherein the floor comprises:
a rear main crossbeam extending in the plane of a frame situated in the service area, wherein the rear main crossbeam is fixed to said frame;
a port main spar and a starboard main spar, wherein each of the main spars has a rear end fixed to the rear main crossbeam;
one or more secondary crossbeams, fixed to the port and starboard main spars, wherein the one or more secondary crossbeams are not fixed to any frame, and are borne by the main spars, wherein the floor does not comprise any crossbeam fixed to a frame in the cockpit; and
one or more auxiliary spars.

2. The anterior zone of an aircraft according to claim 1, wherein each of the port and starboard main spars has a front end fixed to a structural element of the front landing gear compartment.

3. The anterior zone of an aircraft according to claim 2, wherein the structural element of the front landing gear compartment forms part of a horizontal section of roof of the gear compartment.

4. The anterior zone of an aircraft according to claim 1, wherein:
the one or more secondary crossbeams extend only from the port main spar to the starboard main spar, and
the one or more floor panels cover a surface delimited transversely by the port and starboard main spars such that there remain two lateral bands without crossbeam and floor panel.

5. The anterior zone of an aircraft according to claim 1, further comprising a reinforcing crossbeam fixed to a frame situated in the service area, in front of the rear main crossbeam.

6. The anterior zone of an aircraft according to claim 1, further comprising a port reinforcing spar and a starboard reinforcing spar, each of the port reinforcing spar and the starboard reinforcing spar having a rear end fixed to the rear main crossbeam.

7. The anterior zone of an aircraft according to claim 6, wherein each of the port and starboard main spars has a front end fixed to a structural element of the front landing gear compartment, and
wherein each of the port reinforcing spar and the starboard reinforcing spar has a front end fixed to the structural element of the front landing gear compartment.

8. The anterior zone of an aircraft according to claim 1, wherein the auxiliary spars do not extend over all of the longitudinal dimension of the anterior zone.

9. An aircraft comprising an anterior zone according to claim 1.
